(19) United States
(12) Patent Application Publication
(10) Pub. No.: US 2011/0184765 A1
(43) Pub. Date: Jul. 28, 2011

(54) System and Method for a Healthcare Provider to Obtain, Distribute, and Track Pharmaceutical Samples

(76) Inventor: Mark E. Frankel, Lowergwynedd, PA (US)

(21) Appl. No.: 13/085,416

(22) Filed: Apr. 12, 2011

Related U.S. Application Data
(63) Continuation-in-part of application No. 11/820,564, filed on Jun. 21, 2007, now Pat. No. 7,912,578.
Application No. 11/820,564 is a continuation-in-part of application No. 11/476,220, filed on Jun. 27, 2006, now Pat. No. 7,483,766.
(60) Provisional application No. 61/322,939, filed on Apr. 12, 2010.

(51) Int. Cl. G06Q 50/00; G06F 17/00

(52) U.S. Cl. 705/3; 700/231; 700/236

(57) ABSTRACT

A system and method of supplying prepackaged pharmaceutical samples to healthcare providers in the employ of a healthcare organization. A vending machine is provided. The healthcare organization preauthorizes various types of pharmaceutical samples to be stocked within the vending machine. The vending machine is stocked only with the pharmaceutical samples that were preauthorized by the healthcare organization. Although the vending machine is accessible to healthcare providers in a particular office, not all of the prepackaged pharmaceutical samples can be vended by all of the healthcare providers. Rather, each healthcare provider has a sample dispensing authorization that depends upon the healthcare provider's knowledge of the pharmaceuticals. A trackable history is maintained about what pharmaceutical samples were vended, what healthcare provider took the pharmaceutical samples, and what patient was given the pharmaceutical samples.

### RELATED APPLICATIONS

The present application is a continuation-in-part of U.S. patent application Ser. No. 11/820,564, filed Jun. 21, 2007, which is a continuation-in part of U.S. patent application Ser. No. 11/476,220, filed Jun. 27, 2006, now U.S. Pat. No. 7,483,766.

This application also claims priority of U.S. Provisional Patent Application No. 61/322,939, filed Apr. 12, 2010.

### BACKGROUND OF THE INVENTION

1. Field of the Invention

In general, the present invention relates to automated systems that distribute prepackaged pharmaceuticals. More particularly, the present invention relates to automated systems that control access to prepackaged pharmaceuticals and process useful data generated by the dispensing of prepackaged pharmaceuticals.

2. Prior Art Description

In a recent poll, over seventy-eight percent of physicians report that they distribute drug samples to patients in their practice. Drug samples are very useful to a physician. Using drug samples, a physician can provide medications to a patient who cannot, or will not, purchase those medications from a pharmacy. Using samples, a physician can also provide a patient with an immediate dosing of a medication, without having to wait for a prescription to be filled at a pharmacy.

Drug samples also enable a physician to evaluate the effectiveness of new drugs. Patients with particular aliments may be provided with sample drugs by a physician. The physician can then directly evaluate the effectiveness of the new drug as compared to the effectiveness of other well-known treatments.

Physicians do not buy pharmaceutical samples. Rather, pharmaceutical samples are provided to physicians by drug company sales representatives. The drug company representatives rely upon the fact that if a doctor has drug samples to give to a patient, most often that doctor will follow the free samples with a prescription for that same drug.

Drug manufacturer representatives are always vying for a physician's time. Physicians seldom allot much time in their schedules for meeting with sales representatives. Consequently, sales representatives often see doctors in the few free moments a doctor may have between patients, appointments and/or procedures. In these short visits, the drug company manufacturer pitches new drugs and explains the benefits and harms of the drug. The process of providing a physician with the details of a new drug is called “detailing” in the industry. The physician's office is then provided with a generous supply of samples to give away to patients. The drug samples are then typically placed in a sample closet, or even a desk drawer, for possible future distribution.

There are many problems associated with the traditional practice of supplying pharmaceutical samples to physicians. For instance, although the drug company sales representative may have detailed one physician in an office, the drug samples are often in a location that is available to all the physicians in that office. Other physicians may provide samples to patient not knowing all the benefits and/or dangers associated with that drug. Furthermore, since the samples are provided by the physician and not a pharmacy, the doctor typically does not have access to the patient's pharmacy records. Consequently, the physician may not be aware of all the other prescriptions a particular patient is taking or how the sample drugs will interact with those prescriptions.

Many physicians' offices and other healthcare organizations are becoming increasingly concerned about the liabilities that may arise out of the unmanaged distribution of drug samples. There are liabilities associated with unexpected adverse reactions and adverse drug interactions. There are concerns about tracking expiration dates and lot numbers. There is also no system for collecting data regarding the samples so that drug manufacturers can be informed of problems or even of positive feedback.

The traditional practice of supplying pharmaceutical samples to physicians is also problematic to drug companies. To create drug samples, drug companies must package large numbers of individual samples. The sample packaging is often made bold to promote recognition of the sample by a physician in a sample closet. The samples must then be personally brought to physicians by representatives. The cost and manpower required to personally supply samples to every physician's office in the country is staggering. The drug company representatives typically must repeatedly call and visit offices before they are permitted any access to a physician or office decision maker. Once granted access, the time allotted is often too short to make an effective presentation. Furthermore, the drug company representative must repeatedly visit offices, because they have no data regarding how many samples have been given away and when more supplies are needed.

The traditional drug sample distribution system clearly favors large drug companies that have many representatives and a lot of money to spend supporting the efforts of those representatives around the country. Small drug companies with only a few representatives may never be able to penetrate more than a small fraction of the market. This prevents useful new drugs from being effectively introduced to physicians and patients.

A need therefore exists for a new system of distributing drug samples, where the drug samples are provided to physicians without pressure from representatives. A need also exists for a new system for distributing sample drugs where the sample drugs are fully tracked and where ample information about the drugs is provided to the physicians offering those drugs. These needs are met by the present invention as described and claimed below.

### SUMMARY OF THE INVENTION

The present invention is a system and method of supplying prepackaged pharmaceutical samples to healthcare providers in the employ of a healthcare organization.

A vending machine is provided that is accessible to healthcare providers in an office. The healthcare providers work for a healthcare organization that runs the office. The healthcare organization preauthorizes various types of pharmaceutical samples to be stocked within the vending machine. The vending machine is stocked only with the pharmaceutical samples that were preauthorized by the healthcare organization.

Although the vending machine is accessible to healthcare providers in a particular office, not all of the prepackaged pharmaceutical samples can be vended by all of the healthcare providers. Rather, each healthcare provider has a sample dispensing authorization that depends upon the healthcare provider's knowledge of the pharmaceuticals. Once a healthcare provider is fully informed of the risks and benefits of a prepackaged pharmaceutical, then that healthcare provider is given authorization to obtain that prepackaged pharmaceutical from the vending machine.

A trackable history is maintained about what pharmaceutical samples were vended, what healthcare provider took the pharmaceutical samples, and what patient was given the pharmaceutical samples. In this manner, pharmaceutical samples can be tracked for effectiveness, drug interactions and easy recall.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic of the present invention system integrated into a healthcare provider's office;

FIG. 2 is a block diagram illustrating the methodology of stocking and operating the vending machine component of the present invention system; and

FIG. 3 is a block diagram illustrating the overall methodology of data management utilized by the present invention system.

### DETAILED DESCRIPTION OF THE DRAWINGS

Although the present invention system and method can be used to convey controlled samples other than pharmaceuticals, the present invention is particularly well suited for use in dispensing pharmaceutical samples. Accordingly, the present invention system and method is described for use in conveying pharmaceutical samples in a healthcare provider's office, in order to set forth the best mode contemplated for the invention.

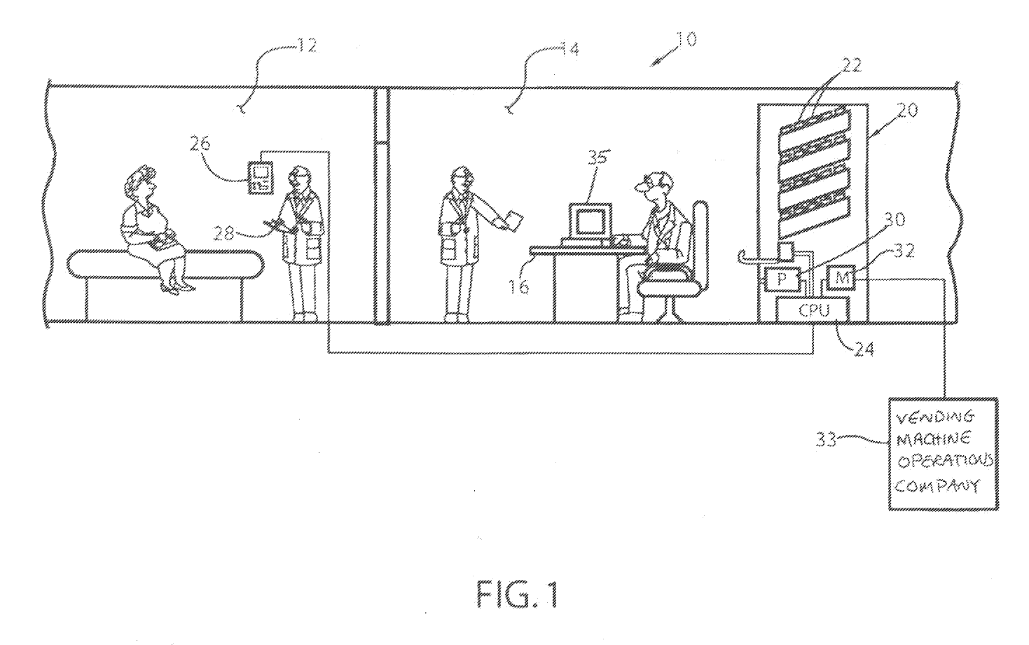

Referring to FIG. 1, a schematic of a physician's office 10 is shown that contains an exemplary embodiment of the present invention system. As is typical, the physician's office 10 includes an examination room 12 and an office area 14. The examination room 12 is the room where physicians physically examine patients. The office area 14 typically is a restricted area that is only used by office personnel. The office area 14 usually has a countertop 16 that separates the office area 14 from public areas used by the patients coming and going.

The present invention system utilizes a custom vending machine 20 to store pharmaceutical samples prepackaged in units of use. A unit-of-use is a bottle, jar, vial, tube, syringe, package or other receptacle that is prefilled with a pharmaceutical in a volume large enough to at least begin a course of treatment. The vending machine 20 is preferably kept in the restricted office area 14. However, the vending machine 20 may be present in public areas for direct access by patients.

The vending machine 20 contains a stock of prepackaged pharmaceutical samples 22. The prepackaged pharmaceutical samples 22 kept in the vending machine 20 depend upon the type of physician's office. In a pediatric physician's office, the vending machine 20 might, among other things, contain various antibiotic samples suitable for children of different weights and ages. In a geriatric physician's office, the vending machine 20 might contain, among other things, prepackaged samples 22 for arthritis and hypertension. It will therefore be understood that the vending machine 20 will be stocked with the prepackaged samples 22 that are most typically prescribed by the physicians in that office.

The vending machine 20 contains a central processing unit 24. The central processing unit 24 controls the vending mechanisms within the vending machine 20. As will later be explained, the central processing unit 24 also keeps track of the stock inventory carried and conveyed by the vending machine 20.

A data input terminal 26 is provided. Although the data input terminal 26 can be located anywhere, it is preferred that each of the examination rooms 12 be provided with a data input terminal 26. The data input terminal 26 can be a panel that is mounted to a wall, a tabletop computer terminal or a portable handheld device. Each of the data input terminals 26 communicate with the central processing unit 24 using either a hard wire or a radio frequency network.

Each of the data input terminals 26 can only be activated by an authorized physician from that office. The data input terminal 26 may be activated by the physical input of an access code or password. The data input terminal 26 may also be activated by swiping an identification card or providing some biometric data, such as a fingerprint. Furthermore, the data input terminal 26 may be activated by a radio frequency identification (RFID) tag that is carried by the physician. Regardless of the method of authorization, what is of primary importance is that the access to the input terminal 26 be controlled and limited to authorized physician use.

The data input terminal 26 contains a screen. Once activated, the physician is provided with a choice of prepackaged pharmaceutical samples 22 within the vending machine 20. The number of prepackaged pharmaceutical samples 22 held within the vending machine 20 is limited by the capacity of the vending machine 20. Thus, the vending machine 20 in an office is filled with a selection best suited for the patients served by that office. The process of selecting the prepackaged pharmaceutical samples 22 for a particular office is explained later in more detail. The selections offered by the vending machine 20 can be presented to the physician on the data input terminal 26 in the form of a selection menu. The physician therefore need only select one of the menu choices to complete a transaction.

The central processing unit 24 in the vending machine 20 is coupled to a printer 30. The printer 30 can be a tabletop printer. However, in the shown embodiment, the printer 30 is contained within the structure of the vending machine 20.

A modem 32 is coupled to the central processing unit 24. The modem 32 enables the central processing unit 24 to communicate with a remote vending machine operations company 33, via some existing telecommunications network. In this manner, the central processing unit 24 can keep the remote vending machine operations company 33 aware of the inventory and age of the prepackaged pharmaceutical samples 22 within the vending machine 20. Periodically, or as needed, the remote vending machine operations company 33 will send a person to restock, replace or remove the prepackaged pharmaceutical samples 22 from the vending machine 20.

The central processing unit 24 also communicates with the physician's electronic medical record system, via an office computer 35. In this manner, when a prepackaged pharmaceutical sample 22 is selected for a particular patient, that information may be saved on the medical records of that patient. This provides the physician's office with the opportunity to cross-reference the prepackaged pharmaceutical samples 22 with other pharmaceuticals the patient may be taking.

Having described an exemplary physical layout of the present invention system, the system's method of operation can now be described. What is first described is how the prepackaged pharmaceutical samples 22 are supplied to the vending machines 20.

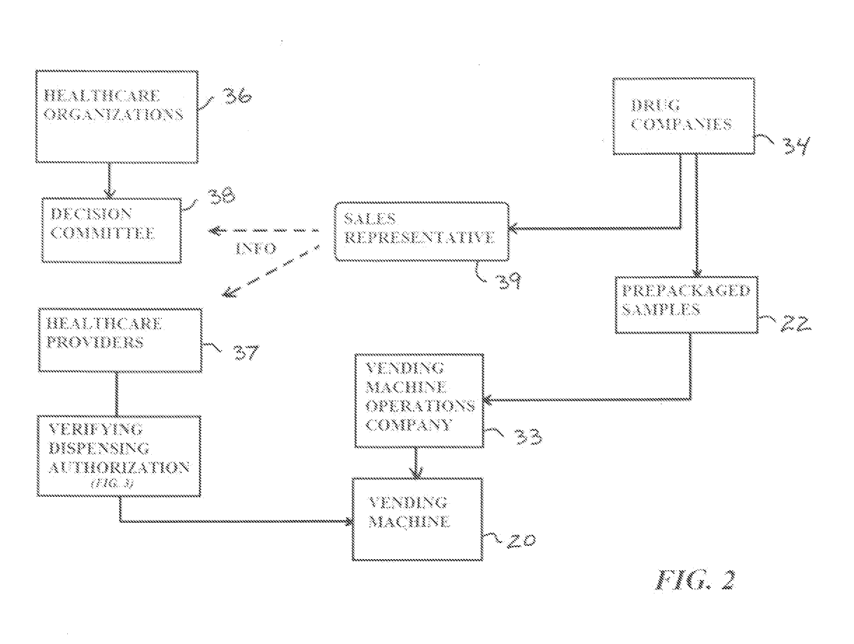

Referring to FIG. 2, a schematic is shown that explains the system for stocking the vending machine 20. The vending machine 20 is owned and operated by a vending machine operations company 33 that is independent of both the drug companies 34 and the healthcare organization 36 that hosts the vending machine 20. The vending machine operations company 33 is screened and licensed to stored and supply pharmaceuticals.

The vending machine operations company 33 places vending machines 20 and the associated hardware into the offices of a healthcare organization 36. Healthcare providers 37 work for the healthcare organization 36. The health care providers 37 can be any individuals with authority to prescribe pharmaceuticals to an individual patient. The vending machine operations company 33 is responsible for providing, stocking and servicing the vending machine 20.

The vending machine 20 can be leased to a healthcare organization 36. However, this method of payment is not preferred. Since the present invention system saves the most money for the drug companies, the vending machine operations company 33 makes money by charging stocking fees to the drug companies 34 when their pharmaceuticals are stocked in the vending machine 20.

The stock of the vending machine 20 is determined by the healthcare organization 36. Large healthcare organizations 36 can establish decision committees 38 to determine what prepackaged pharmaceutical samples 22 should be stocked within their offices. The healthcare organization's decision committees 38 can speak directly to drug company representatives 39 and schedule comprehensive presentations. In this manner, the drug company representatives 39 are not hurried. The healthcare organization decision committees 38 can take the time to review data, ask questions and receive follow-up information. Once the healthcare organization decision committee 38 approves a drug, it can be stocked within the vending machine 20. The healthcare organization decision committee 38 informs the drug companies 34 as to what prepackaged pharmaceutical samples 22 are to be provided. The drug companies 34 create the requested prepackaged pharmaceutical samples 22. The prepackaged pharmaceutical samples 22 can be packaged in simple inexpensive packaging. Since the prepackaged pharmaceutical samples 22 are held within the confines of the vending machine 20, the packaging need only be functional in protecting the pharmaceutical sample 22. The drug companies 34 can therefore save money by not using expensive packaging.

Large healthcare organizations 36 may have hundreds of healthcare providers 37 in dozens of offices. Drug companies 34 need only make a single presentation to get a drug sample made available in all of these locations. Drug companies 34 can therefore save large sums of money by eliminating the excess manpower previously needed to repeatedly service the same customer base.

Although a healthcare organization 36 may approve certain samples, the healthcare organization 36 may elect not to have all physicians in that organization access those samples. Just because a decision committee 38 of a healthcare organization 36 is fully informed of a drug's benefits and dangers does not mean that all healthcare providers 37 in that organization have obtained the same information. The healthcare organization 36 can hold meetings, seminars, on-line education courses and the like to provide individual healthcare providers 37 with the information they need. Once a healthcare organization 36 is satisfies that a healthcare provider 37 is qualified to dispense certain samples, that healthcare provider 37 will be granted authority to dispense those samples 22 from the vending machine 20.

Small clinics and independent doctor's offices often do not have the resources to hear full presentations from drug representatives. Such smaller healthcare organizations 36 can select their own inventories for the vending machine 20 or may take the recommendation of professional organizations to which they belong. For instance, family doctors may belong to a city or state medical association. That association may put out guidelines for new drugs and hold seminars to inform doctors about those drugs. The seminars may also be held directly by the drug companies 34 if there are many small healthcare providers 37 in a particular community.

Some pharmaceuticals, such as certain cholesterol lowering medications, pain medications and erectile dysfunction medications, have been around for many years and are widely prescribed to the public. Most all physicians who prescribe medications are well versed in the pros and cons of these popular medications. These are also the prescription samples most requested by patients. Such popular prescription samples can be stocked in the vending machine 20 on a supply and demand basis without the need for preapproval by any committee or board.

Once a decision has been made as to what prepackaged pharmaceutical samples 22 are to be kept in a particular vending machine 20, the vending machine 20 is loaded. Upon each loading, the stock contained in a particular vending machine 20 is read to the central processing unit 24 for that vending machine 20. This can be done with a simple barcode scanner, RFID or similar inventory identification technology.

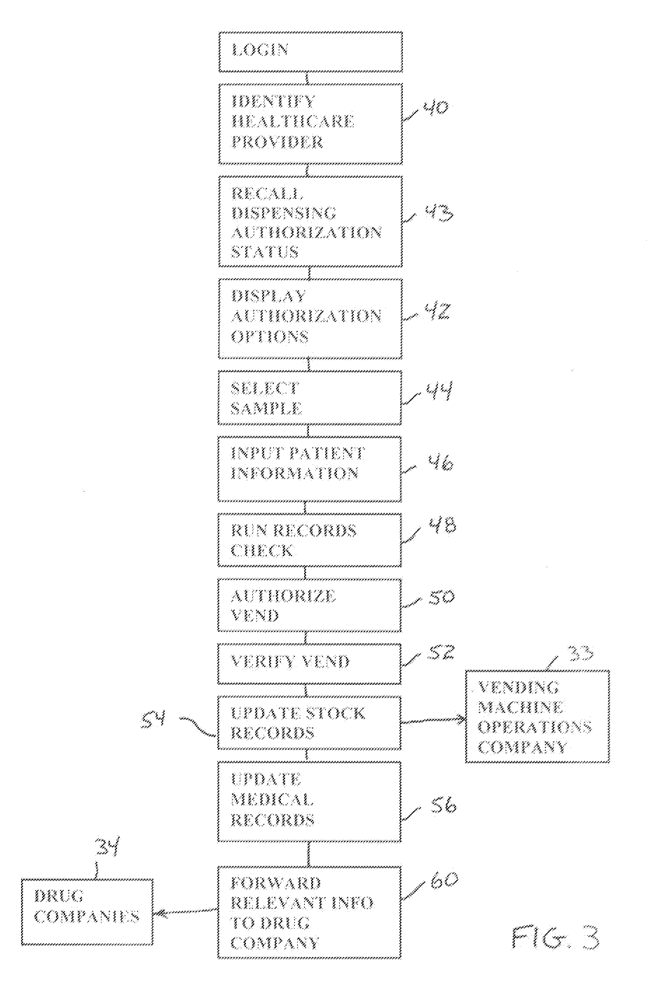

It was previously mentioned that in order to operate the vending machine 20, a healthcare provider 37 has to verify his/her identity using an access card, code or similar identifier. As such, each physician is individually identified by the system. Referring to FIG. 3 in conjunction with FIG. 1, it will be understood that when a healthcare provider 37 logs into the data input terminal 26, the healthcare provider 37 is identified. See Block 40. Some of the stock of the vending machine 20 is displayed to the healthcare provider 37. See Block 42. The healthcare provider 37 is only displayed the vending machine inventory that the healthcare provider 37 is authorized to dispense. This prevents a healthcare provider 37 from dispensing a sample for which he/she is unfamiliar. Healthcare providers 37 are only provided authority to vend the pharmaceutical samples 22 for which they have been fully detailed. Consequently, each healthcare provider 37 in an office has a sample dispensing authorization status. The authorization status for a healthcare provider 37 improves each time the healthcare provider 37 is detailed about a particular drug, either by the healthcare organization 36 or directly by the drug company 34. The sample dispensing authorization status is entered into the central processing unit 24 and is updated as required. In this manner, the central processing unit 24 can determine what physicians are authorized to dispense what pharmaceutical samples. See Block 43.

The healthcare provider 37 selects samples from his/her authorized choices. See Block 44. The healthcare provider 37 must then identify the patient for who the pharmaceutical samples 22 are intended. See Block 46. The selected prepackaged pharmaceutical samples 22 are then compared to the patient's medical file for possible drug interaction problems. See Block 48. If no problems are found, then the vending machine 20 vends. See Block 50. The prepackaged pharmaceutical samples 22 are then manually taken from the vending machine 20 and are verified. See Block 52. The verification process is described in detail in co-pending application Ser. No. 11/820,564, the disclosure of which is incorporated into this application by reference.

Within the vending machine 20, the central processing unit 24 updates the status of the vending machine 20. See Block 54. Information about what was vended and for whom is communicated to the medical record software being run by the office computer 34 in the physician's office 10. See Block 56. In this manner, a patient's records are automatically updated with the prescription ordered by the healthcare provider and the medication that was conveyed.

The central processing unit 24 also forwards updated information to the vending machine operating company 33 that is responsible for filling and maintaining the vending machine 20. In this manner, the vending machine operating company 33 can periodically come to fill the vending machine 20 before the vending machine 20 ever runs low of a particular type of pharmaceutical sample 22. Likewise, if pharmaceutical samples 22 remain in the vending machine 20 and are approaching their expiration dates, these pharmaceutical samples 22 can be removed from the vending machine 20.

The drug companies 34 do not control what prepackaged pharmaceutical samples 22 are selected for a vending machine 20 by a healthcare organization 36. However, if a prepackaged pharmaceutical sample 22 of a particular drug company 34 is selected, that drug company 34 is asked to provide the samples 22 to the vending machine operating company 33. The drug companies 34 also receive information regarding sales. The drug company 34 can then track where, when and to whom certain drugs have been given. In this manner, drug companies 34 can know where the prepackaged pharmaceutical samples 22 are should there be a recall or a manufacturing problem with a particular lot. See Block 60.

Using the present invention system, a healthcare organization 36 can limit liabilities associated with giving away prepackaged pharmaceutical samples 22. Prepackaged pharmaceutical samples 22 can be stored in ideal conditions within a vending machine 20. When prepackaged pharmaceutical samples 22 are taken, the system knows what healthcare provider has ordered the samples and what patient the samples have been given too. Abuse and theft of pharmaceutical samples by physicians and healthcare staff are eliminated. Concerns of expired samples are eliminated. Furthermore, samples can be tracked should they ever have to be recalled.

Drug companies save money by providing simply packaged samples to healthcare providers using a minimum of sales representatives.

Healthcare organizations benefit by eliminating the need to directly meet with drug company sales representatives. Healthcare organizations are also ensured a constant resupply of selected samples.

It will therefore be understood that the present invention system greatly improves the current system of drug sample distribution. It will also be understood that the embodiment of the present invention system that is illustrated and described is merely exemplary and that a person skilled in the art can make many variations to the system. Individual system parts, such as the data input terminals, printers, CPUs and the like come in many different types. All variations of these components are intended to be included within the scope of the invention. Furthermore, the term vending machine is being used in it broadest sense. The vending machine is intended to include all storage devices, including locked storage chests, that can only be accessed upon the activation of some conveying mechanism. All such variations, modifications and alternate embodiments are intended to be included within the scope of the present invention as set forth by the claims.

What is claimed is:

1. A method of supplying prepackaged pharmaceutical samples to healthcare providers in the employ of a healthcare organization, comprising the steps of:
providing a vending machine accessible to said healthcare providers;
having said healthcare organization preauthorize types of pharmaceutical samples to be stocked within said vending machine;
stocking said vending machine only with said pharmaceutical samples preauthorized by said healthcare organization; and
limiting operation of said vending machine to only said healthcare providers.

2. The method according to claim 1, further including the step of charging vending machine stocking fees to manufacture's of said pharmaceutical samples.

3. The method according to claim 1, further including the step of providing a computer control for operating said vending machine.

4. The method according to claim 3, further including the step of tracking with said computer control a stock inventory of said pharmaceutical samples added to, and vended from, said vending machine.

5. The method according to claim 3, further including the step of having said computer control automatically communicate said stock inventory to said healthcare organization.

6. The method according to claim 3, further including the step of having said computer control automatically communicate said stock inventory to a supply company responsible for stocking said vending machine.

7. The method according to claim 1, further including the step of providing a data input port that communicates with said computer control for having one of said healthcare providers input patient information regarding a patient for whom a pharmaceutical sample vended from said vending machine is given.

8. The method according to claim 7, wherein said healthcare organization has medical records, and wherein said computer control automatically updates said medical records with said input patient information.

9. The method according to claim 1, further including the step of assigning drug sample dispensing authorizations to said healthcare providers as said healthcare providers are educated about said pharmaceutical samples.

10. The method according to claim 9, further including the step of having said computer control identify a specific one of said healthcare providers attempting to utilize said vending machine to vend a specific prepackaged pharmaceutical product.

11. The method according to claim 10, further including the step of having said computer control operate said vending machine and vend said specific prepackaged pharmaceutical product only if said specific one of said healthcare providers has a drug sample dispensing authorization for said specific prepackaged pharmaceutical product.

12. A method of providing drug company pharmaceutical samples to healthcare providers at an office of said healthcare providers, said method comprising the steps of:
placing a vending machine in said office, wherein said vending machine has a computer control;
stocking said vending machine with different types of prepackaged pharmaceutical samples,
assigning drug sample dispensing authorizations to at least some of said healthcare providers at said office, wherein said drug sample dispensing authorizations correspond to said prepackaged pharmaceutical samples stocked;
identifying a specific healthcare provider attempting to operate said vending machine; and
enabling said vending machine to vend only prepackaged pharmaceutical samples for which said specific healthcare provider has said drug sample dispensing authorizations.

13. The method according to claim 12, wherein said healthcare providers work for a healthcare organization and wherein said method includes the step of stocking said vending machine only with prepackaged pharmaceutical samples preapproved by said healthcare organization.

14. The method according to claim 12, further including the step of charging a fee to drug manufacturers who manufacture said prepackaged pharmaceutical samples for having said prepackaged pharmaceutical samples stocked in said vending machine.

15. The method according to claim 12, further including the step of tracking with said computer control an inventory of said prepackaged pharmaceutical samples added to, and vended from, said vending machine.

16. The method according to claim 15, further including the step of having said computer control automatically communicate said inventory to said healthcare organization.

17. The method according to claim 12, further including the step of having said computer control automatically communicate said inventory to a supply company responsible for stocking said vending machine.

18. The method according to claim 12, further including the step of providing a data input port that communicates with said computer control for having one of said healthcare providers input patient information regarding a patient for whom a prepackaged pharmaceutical sample vended from said vending machine is given.

19. The method according to claim 18, wherein said healthcare organization has medical records and wherein said computer control automatically updates said medical records with said input patient information.
